(19) United States
(12) Patent Application Publication
(10) Pub. No.: US 2004/0261031 A1
(43) Pub. Date: Dec. 23, 2004

(54) Context dependent auxiliary menu elements

(75) Inventors: Kimmo Tuomainen, Pirkkala (FI); Sanna M. Suomalainen, Tampere (FI); Katja Konkka, Tampere (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/602,540

(22) Filed: Jun. 23, 2003

(51) Int. Cl. G09G 5/00

(52) U.S. Cl. 715/739

(57) ABSTRACT

The invention relates to a method of displaying a menu on a display of an electronic device. The method comprises the steps of displaying one or more selection elements, defining an auxiliary element for at least one selection element, activating one selection element and displaying an auxiliary element only in an active selection element.

### FIELD OF THE INVENTION

The present invention relates generally to an electronic device, and in particular, to a menu displaying method in an electronic device.

### BACKGROUND OF THE INVENTION

At present, mobile phones provide various types of functions in addition to the basic call making/receiving function. Typical examples of the functions include telephone number directories, message management, calling options, voice dialling, electronic organizer, phone manager, and many more. In order to use any of such functions, some mobile phones also comprise a graphical user interface (GUI).

Typically a display of a graphical user interface (GUI) comprises different kinds of selection elements like menus, icons and other elements which are connected to said functions. To navigate between these selection elements there is typically some kind of a control device, such as a navigation key, soft keys, a joystick or a touch screen. The navigation in the user interface is assisted in many different ways. Typically activated selection elements are highlighted and in some user interfaces there are some kinds of semaphores to help the navigation. These semaphores are shown on the edges of the display.

The use and operation of this kind of graphical user interface is familiar to many people especially to young and/or educated people who have used such user interfaces in many situations. But there are also many people who have not used said user interfaces before and they might have some problems in perceiving all those little things in the display. Another major problem is that they do not know where it is possible to navigate to or from the current position. It is especially difficult for the “first timers” to combine the information which is presented in many different places on the display. The user must also look simultaneously at many different points on the display. Such straying of eyes may confuse the user, whereby he or she may find the use of the user interface troublesome.

Another major problem is that the user must make multiple consecutive selections to run some functions. For the first timers this could be very difficult and for the advanced users it is laborious and boring.

### SUMMARY OF THE INVENTION

Accordingly, the present invention relates to a user-friendly menu displaying method in an electronic device that substantially eliminates one or more problems resulting from the limitations and disadvantages of the related art.

It is an object of the present invention to provide a menu displaying method in an electronic device that indicates the directions which are allowed for navigation from the current position and enables a user to select a desired selection element or function.

Another object of the present invention is to provide a menu displaying method in an electronic device that allows a user to focus their attention essentially to a selection element on a menu which is shown on the display.

Yet another object of the present invention is to provide a menu displaying method in an electronic device that allows the user to quickly and easily perform actions relating to active selection elements.

Additional advantages, objects and features of the invention will be set forth in part in the description hereinbelow and in part they will become apparent to those skilled in the art upon examination of the following. The objectives and other advantages of the invention may be realized and attained by the structure particularly pointed out in the written description and claims hereof as well as in the appended drawings.

To attain the objectives and advantages mentioned above, the menu displaying method according to the invention is characterized in that the method comprises the steps of displaying one or more selection elements, and displaying an auxiliary element as a selection symbol and/or a sempahore in the active selection element, the auxiliary element being located close to an identifier of the active selection element, and indicating by the semaphore those directions, to which it is possible to navigate from an active selection element, and/or indicating by the selection symbols those functions that can be selected, and hiding the selection symbols and/or the semaphore from the non-active selection element.

One embodiment of the present invention comprises arrow-type navigation aids. These arrows pop up only when a selection element is active and indicate the allowed directions of navigation. When the user looks at an active selection element, he or she at the same time sees the arrows without having to look at a new point. If the user moves the cursor to the next selection element, the arrows of the new active selection element pop up and the arrows of the non-active selection element are hidden.

Another embodiment of the present invention comprises a context dependent shortcut menu, such as push-button type selection symbols. These selction symbols pop up only when a selection element is active and indicate the allowed functions. When the user looks at an active selection element, he or she at the same time sees the selection symbols without having to look at a new point. If the user moves the cursor to the next selection element, the selection symbols of the new active selection element pop up, and the selection symbols of the non-active selection element are hidden. If the user selects one of the selection symbols of the active selection element, he or she can, for example, perform a function, jump to a new location in the application or start a new application. For example, the user could be browsing through the “Contacts” directory and there could be a selection symbol for “Send SMS” functionality. If the user selects this selection symbol, a messaging application is launched and the mobile telephone number from that contact card is automatically transferred to the recipient field of the new SMS-message.

Another embodiment of the present invention includes a dynamic magnifying feature. In this case the active selection element is magnified on the display. The magnifying can be focused only on one element, or submenu, or part of the tool bar or a combination of these. This embodiment is very useful for mobile phones and PDA's (personal digital assistant) with small displays and/or for users with poor eyesight.

### BRIEF DESCRIPTION OF THE DRAWINGS

The above and other objects, features and advantages of the present invention will become more apparent from the following detailed description when taken in conjuction with the accompanying drawings in which:

FIGS. 1-2 illustrate exemplary menu windows of a mobile terminal according to an embodiment of the present invention

FIG. 3 illustrates a second embodiment of the present invention,

FIG. 4 illustrates third exemplary menu windows of a mobile terminal.

### DETAILED DESCRIPTION OF THE PREFERRED EMBODIMENT

A preferred embodiment of the present invention will be described hereinbelow with reference to the accompanying drawings. In the following description well-known functions and/or constructions will not be described in detail since they would obscure the invention.

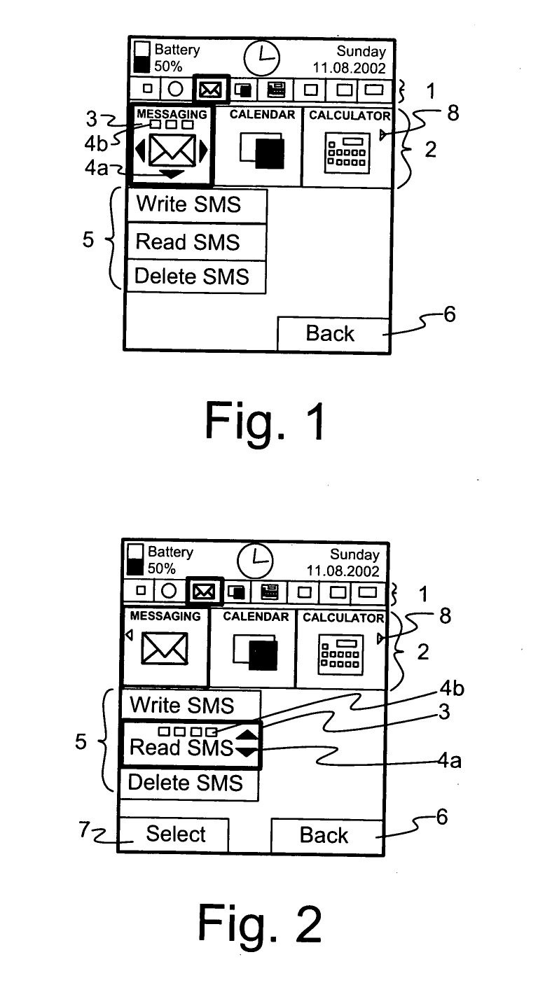

FIG. 1 shows a view on the display of a user interface according to one embodiment. Said view comprises at least a first selection element level as a tool bar 1, in which some allowable functions are shown. In this context the explanation tool bar 1 refers to the first selection element level and covers all bar-type controllers, such as menu bars and tool bars. FIG. 1 shows said basic tool bar 1 and a magnified part 2 of said tool bar. Large figure of this kind make the use of the menu and functions more comfortable.

In FIG. 1 a highlighted active selection element 3 (MESSAGING) is shown in the magnified tool bar 2. Navigation aids 4a, which in this embodiment are arrows, are shown in said active selection element 3. These arrows 4a indicate the directions which are allowed for navigation. From said active selection element 3 it is possible to move to the left, to the right and downward. Selection aids 4b, which in this embodiment are selection symbols which form a shortcut menu, are shown in said active selection element 3. These selection symbols 4b indicate the functions which can be used quickly. From said active selection element 3 it is possible to choose three different functions by using the shortcut menu of the active selection element. These functions can be the same as the ones shown in a submenu 5, or there can be some other functions, such as “jump to the application X” functions. Usually it is advantageous if these functions are the most frequently used functions of the submenu 5 of the selection element 3. The symbol 4b which represents one function can be selected by using a suitable control device, such as a navigation key, soft keys, a joystick or a touch screen.

In this example, all the second selection element levels as submenus 5 of the active selection element 3 are shown in the view automatically. In this context the explanation submenu 5 refer to the second selection element level and covers all different kinds of submenus, such as pull-down menus, pop-up menus, drop-down menus and other types of submenus. It is possible to hide these submenus 5 first, and show them only if the user so desires (for example by pushing the navigation key down) as shown later in FIG. 4. But it is in many embodiments more user-friendly if the user can see these submenus 5 without any extra effort.

These auxiliary elements, said navigation aid arrows 4a and selection aid symbols 4b are situated very close to the description (text or/and figure) of the active selection element 3 so that they are advantageously in the centre of users attention all the time. Of course it is still possible to show other information in other parts of the display, as in FIG. 1 the text “Back” 6 in the the bottom portion of the display. There are also arrows 8 in the ends of the magnified tool bar 2. These arrows 8 indicate only that the tool bar 1 is longer that shown in the magnified part 2.

From the active selection element 3 (MESSAGING) it is possible to move to the left, to the right and downward, as mentioned before. When movement is directed downward, a selection element 3 of the submenu 5 is activated. FIG. 2 shows a view of the display where the active selection element 3 is situated in said submenu 5. The navigation aids 4a, said arrows, and selection aids 4b, said symbols, are now shown in the active selection element 3 (Read SMS). In the non-active selection elements these arrows and symbols are hidden. From this active selection element 3 (Read SMS) movement is allowed only up or down, as said arrows 4a indicate. Four selection symbols 4b in this active selection element 3 indicate that there are now four guickly selectable functions. It also possible to select a Read SMS-function. This possibility is indicated in this embodiment by the text “Select” 7 in the bottom portion of the display. Of course, the indication of selecting possibilities can be implemented in many other ways, for example by using colours, symbols etc.

There are several advantages which can be attained by hiding the auxiliary elements 4a, 4b from the non-active selection elements. One advantage is that there is no meaningless navigation aids 4a and selection aids 4b on the display. Another advantage is that there is more space to show useful information, or it is possible to use bigger figures or larger fonts. Generally the view of the user interface is much more user-friendly if context dependent navigation aids 4a and selection aids 4b are utilized. The following embodiments illustrate some ways to enhance the perceptivity of the active selection element 3. These embodiments are very useful for small displays and/or for users with poor eyesight.

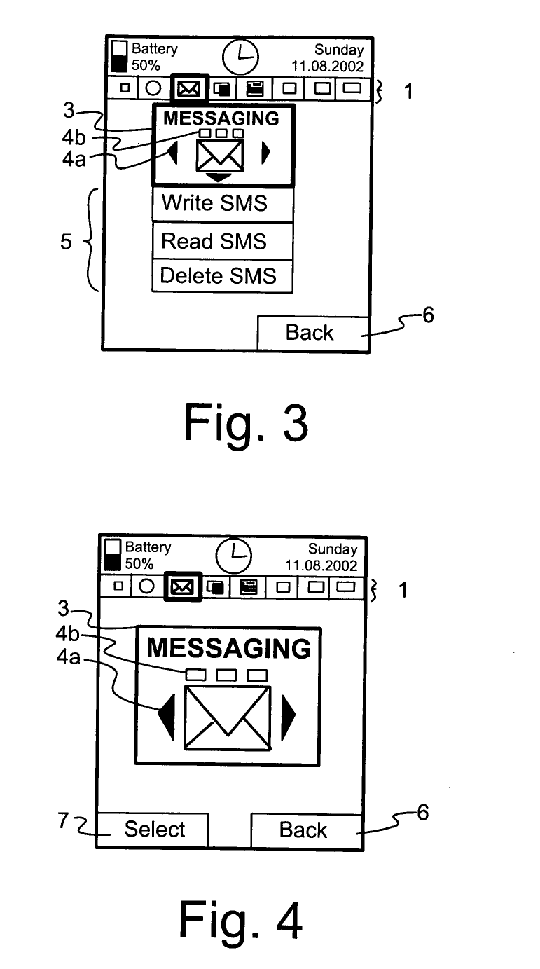

FIG. 3 shows a second embodiment of the present invention. This embodiment only contains a basic tool bar 1 shown on the display, and excluding the magnified part 2 of the tool bar of the previous embodiment. The highlighted symbol (envelope) of the active selection element 3 is shown in the tool bar 1 and at the same time a large selection element 3 with said navigation aids 4a and selection aids 4b is shown on the display. The submenu 5 of the active element 3 is also shown automatically. Furthermore in that embodiment the arrows 4a indicate the three selectable directions and symbols 4b indicate the three selectable functions.

FIG. 4 illustrates a third example containing only a basic tool bar 1 on the display, excluding the magnified part 2 of the tool bar of the first embodiment. The highlighted symbol (envelope) of the active selection element 3 is shown in the tool bar 1, similarly to the previous embodiment, and at the same time a large selection element 3 with said navigation aids 4a and selection aids 4b is shown on the display. Now there are only arrows 4a to the right and to the left, indicating that it is possible to move only to these two directions by using the navigation key. The three selection symbols 4b indicate the three selectable functions, which might be for example write, read and delete sms (short message) or jump to the organizer etc. The text “Select” 7 in the bottom part of the display indicates that it is also possible to select said messaging function.

In the foregoing embodiments and examples there were from one to three indicated directions in an active selection element 3. There can, of course, be a large number of such directions depending on the application and/or hardware in use. It is also possible to use other types of indicators 4a, 4b than said arrows and symbols, such as fingers, letters etc. In some embodiments the user can select the type of indicator that is used. The user can also define the actions the selection aids 4b are referring to. Another possibility is that the actions are determined on the basis of the behavior of the user, so that actions that are used more often are shown in the selection aids 4b.

In the foregoing embodiments and examples the navigation aids 4a and selection aids 4b were shown simultaneously in the active selection element 3. It is possible to show only navigation aids 4a or selection aids 4b in the active selection element 3, and in some embodiments it is more user-friendly to show only the navigation aids 4a or the selection aids 4b. In some embodiments the combination of the auxiliary elements depends on the location of the menu tree (in some activated elements only navigation aids 4a or selection aids 4b or both are shown). In some other embodiments the user can define the used auxiliary elements.

The foregoing embodiments of the method for displaying a menu on a display of a mobile terminal is implemented advantageously by means of a program. In one embodiment the program is saved on the memory of a mobile terminal, such as a mobile phone or PDA.

The foregoing embodiments are merely disclosed herein as examples and should not to be taken as limitations of the present invention. The present teachings can be readily applied to other types of apparatusess. The description of the present invention is intended to be illustrative, and not to limit the scope of the claims. Many alternatives, modifications and variations will be apparent to those skilled in the art.

What is claimed is:

1. A method of displaying a menu on a display of an electronic device, the method comprising the steps of
displaying one or more selection elements,
defining an auxiliary element for at least one selection element,
activating one selection element, and
displaying an auxiliary element only in an active selection element.

2. The method of claim 1, further comprising the steps of,
selecting a selection element,
defining a submenu for the selection element,
magnifying said selection element,
displaying a submenu, and
displaying an auxiliary element.

3. The method of claim 2, wherein one selection element of a submenu is activated and an auxiliary element is displayed on the activated selection element of the submenu.

4. The method of claim 1, wherein the auxiliary element is not shown in the non-active selection element.

5. The method of claim 1, wherein the auxiliary element displays at least one indicator indicating the possible navigating directions.

6. The method of claim 5, wherein the indicator is an arrow pointing to one possible navigating direction.

7. The method of claim 1, wherein the auxiliary element displays at least one indicator indicating a selectable function.

8. The method of claim 7, wherein the indicator is a shortcut menu.

9. The method of claim 1, wherein said auxiliary element is located close to an identifier of the active selection element.

10. The method of claim 1, wherein the identifier of the selection element is at least one of the following: an icon, an object, a figure, a text, or a cell of a menu.

11. A graphic user interface (GUI) of an electronic device, the function of the GUI being to present various menus, wherein
the display format comprises one or more selection elements,
at least one selection element comprises an auxiliary element, and
only an active selection element comprises a visible auxiliary element.

12. The graphic user interface of claim 11, further comprising at least one magnified selection element of the first selection element level.

13. The graphic user interface of claim 11, wherein the auxiliary element comprises at least one indicator indicating the possible navigating direction.

14. The graphic user interface of claim 13, wherein the indicator is an arrow pointing to one possible navigating direction.

15. The graphic user interface of claim 11, wherein the auxiliary element comprises at least one indicator indicating the selectable function.

16. The graphic user interface of claim 15, wherein the indicator is a shortcut menu.

17. The graphic user interface of claim 11, wherein the selection element comprises an identifier of the element and an auxiliary element which are located close to said identifier.

18. The graphic user interface of claim 11, wherein the identifier of the selection element is at least one of the following: an icon, an object, a figure, a text, or a cell of a menu.

19. A mobile phone comprising a graphic user interface (GUI), the function of the GUI being to present various menus wherein
the display format comprises one or more selection elements,
at least one selection element comprises an auxiliary element, and
only an active selection element comprises a visible auxiliary element.

20. The mobile phone of claim 19, wherein the auxiliary element is arranged to indicate at least one of the following
the directions to which it is possible to navigate from an active selection element,
the possible selectable functions.

21. A personal digital assistant (PDA) comprising a graphic user interface (GUI), the function of the GUI being to present various menus wherein
the display format comprises one or more selection elements,
at least one selection element comprises an auxiliary element, and
only an active selection element comprises a visible auxiliary element.

22. A software program for displaying a menu on a display of an electronic device, the program comprising a number of instructions which, when executed by a processor, prompts the processor to perform the steps of
displaying one or more selection elements,
defining an auxiliary element for at least one selection element,
activating one selection element, and
displaying an auxiliary element only in an active selection element.

23. The software program of claim 22, that also performs at least one of the following steps of
indicating the possible navigating directions from the active selection element by the means of the auxiliary element,
indicating the possible selectable functions of the active selection element by the means of the auxiliary element.

24. A storage medium readable by a computer, said medium containing information stored therein, which information, when executed by a processor, prompts the processor to perform the steps of
displaying one or more selection elements,
defining an auxiliary element for at least one selection element,
activating one selection element, and
displaying an auxiliary element only in an active selection element.

25. The storage medium of claim 24, that also performs at least one of the following steps of
indicating the possible navigating directions from the active selection element by the means of the auxiliary element,
indicating the possible selectable functions of the active selection element by the means of the auxiliary element.
